(19) United States
(12) Patent Application Publication
(10) Pub. No.: US 2025/0242286 A1
(43) Pub. Date: Jul. 31, 2025

(54) MULTI-PLY FILTER SCREEN ASSEMBLY FOR USE WITH AN AIR INTAKE OPENING

(71) Applicant: The Newway Company, Commerce Township, MI (US)

(72) Inventor: Randy Simmons, West Chester, OH (US)

(21) Appl. No.: 18/425,438

(22) Filed: Jan. 29, 2024

(51) Int. Cl. B01D 46/12; B01D 46/62

(52) U.S. Cl. CPC B01D 46/12; B01D 46/62; B01D 2265/02; B01D 2275/10

(57) ABSTRACT

A filter assembly for securing to an intake face of an air handling unit including a base mesh ply adapted to being secured to the intake face in order to cover an opening of the air handling unit. An outer mesh ply is attached to the base mesh ply, with the outer ply being manipulated to permit access to the base ply without removal of the base ply from the air handling unit. A tertiary ply can be removably inserted between the base mesh ply and outer ply.

### FIELD OF THE INVENTION

The present invention relates generally to filter screen assemblies. More specifically, the present invention teaches a variety of configurations of a multi-ply filter (also termed as a “flap filter”) for application to an air intake opening and which provides for ease of cleaning without removal from the equipment, as well as for varying airflow, such as by removal of a ply, during higher static pressure levels.

### BACKGROUND OF THE INVENTION

Filtration assemblies are known in the prior art, an objective of which is the ability to modify the performance characteristics, including the rate of airflow through the filter screen, in order to optimize performance in a given application.

US 2022/0305425 to Eifes, teaches a filter including multiple filter layers in plurality with the structural integrity of the filter as a whole. The layers are perforated to allow any type of filtering such as but not limited to osmosis filtering, reverse osmosis filtering, static filtering, and sifting or sieve-like filtering effect as the media being filtered passes through the layers as the outermost layer collects most debris. The layers further have an adhesive relationship with each other layer and an optional base layer, so that each layer may be individually removed and the one beneath is exposed as a cleaner filter surface.

US 2007,0220856, to Cho et al., teaches a metal fiber media for an exhaust gas purifier having a metal fiber mat constructed of outer layers of wire meshes 2/2′ sandwiching a metal fiber yarn 3.

U.S. Pat. No. 5,817,168 teaches a filter system for an HVAC assembly including each of a frame 200, a conventional air permeable filter 300 and a scent impregnated outer grid 400. See also Lee U.S. Pat. No. 10,143,953.

Finally, U.S. Pat. No. 11,732,924 (also US 2023/0392825), to Huang, teaches a multi-level fine filter for an HVAC system including The filter assembly includes a first layer of a first coarse mesh, a second layer of a second coarse mesh, and a fine filter disposed between the first layer and the second layer. Additionally, the fine filter includes an upper level and a lower level with respect to the airflow, and wherein the lower level facilitates accumulation of fine debris captured from the airflow entering the air intake of the HVAC unit.

### SUMMARY OF THE INVENTION

The present invention teaches a variety of configurations of a multi-ply filter (or flap filter) for application to a variety of applications to an air intake opening, which provides for each of ease of cleaning without removal from the equipment, as well as for varying airflow, such as by removal of a ply, during lower static pressure levels.

In each variant, a base mesh ply is adapted to being secured to the intake face in order to cover an opening of the air handling unit. An outer mesh ply is attached to the base mesh ply, the outer ply being manipulated to permit access to the base ply without removal of the base ply from the air handling unit.

In most variants, at least the base mesh ply incorporates a reinforced edge with spaced apart grommets receiving fasteners, including without limitation any of twist or toggle lock fasteners, twist lock fasteners, screws, hook and loop fasteners or the like, for securing to the intake face. The base and outer mesh plies are typically, however not exclusively in every embodiment, joined together along at least one common edge.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an unfolded plan view of a flap-style dual filter assembly according to a non-limiting variant of the present invention and depicting first and second plies of varying mesh thickness (outer ply having larger mesh and inner/base ply having finer mesh) which are bound along a common edge for attachment to an intake face of such as an air handling unit;

FIG. 2 presents a side plan view of the filter assembly of FIG. 1 in a substantially folded and overlapping configuration in which the perimeter arranged supporting grommets and reinforced edges are aligned prior to attachment to the intake face;

FIG. 3 is an exploded perspective view of a dual filter assembly according to a further non-limited variant of the present invention depicting a zipper connection along a common edge established between the outer and base plies, the present invention also contemplating a further related variant in which the plies are separately provided without a zippered connection;

FIG. 4 is a side plan view of the filter assembly of FIG. 3 and similarly depicting the overlapping configuration in which the perimeter arranged supporting grommets and reinforced edges are aligned prior to attachment to the intake face;

FIG. 5 is an exploded environmental view of a dual filter assembly according to a further preferred embodiment and including a base ply with outer perimeter edge grommets secured to the air intake face via twist lock fasteners, toggle style fasteners, screws or other such fastening methods; an outer ply having a modified and segmented outer perimeter with cutouts aligning with the arrangement of the fasteners, with each of the base and outer plies exhibiting opposing hook and loop (e.g. Velcro®) portions for releasably attaching the outer ply without requiring removal of the base ply;

FIG. 6 is a side plan view of the filter assembly of FIG. 5 and similarly depicting the overlapping configuration in which the perimeter arranged supporting grommets of the base layer and the cutout locations of the upper mesh layer are aligned upon attachment to the intake face;

FIG. 7 is an exploded environmental view of a dual filter assembly according to a further preferred embodiment and including spin lock fasteners for securing a base ply similarly constructed that shown in FIG. 5 and secured over threaded posts projecting from the air intake face, the outer ply likewise being similarly constructed as in FIG. 5 and releasably securing to the base ply via opposing hook and loop fasteners;

FIG. 8 presents an exploded view of a further variant of a dual filter assembly and depicting a base ply attached to the intake face by a first set of hook and loop fasteners, with the outer ply secured to the base ply via a second set of hook and loop fasteners arranged upon opposing reinforced edges of the base and outer plies;

FIG. 9 is an exploded view similar to FIG. 7 of a modified spin lock fastener mounting arrangement for the dual filter assembly utilizing a four sided track assembly mounted to the air intake face for supporting the threaded bolts, without limitation this configuration also utilizing the Twist lock fasteners as depicted in FIG. 5, alternately, utilizing toggle style fasteners;

FIG. 10 presents a further exploded perspective view of a mounting arrangement for the dual filter assembly including screw and washer mounting fasteners in combination with an uninterrupted exterior edge of the outer ply for securing over the flattened heads of the screws via the opposing arrangements of hook and loop fasteners established between the mesh plies;

FIG. 11 is an exploded environmental view of a dual filter assembly according to a further preferred embodiment largely identical to that shown in FIG. 5 and including the base ply with outer perimeter edge grommets secured to the air intake face via toggle lock fasteners (as opposed to the twist lock fasteners shown in FIG. 5), the outer ply having modified and segmented outer perimeter cutouts aligning with the arrangement of the fasteners, with each of the base and outer plies exhibiting opposing hook and loop (e.g. Velcro®) portions for releasably attaching the outer ply without requiring removal of the base ply;

FIG. 12 presents an exploded view similar to as shown in the embodiment of FIG. 9 and in which the spin lock fasteners are substituted by twist lock fasteners mounted within the perimeter defining tracks;

FIG. 13 is an illustration of a further configuration of dual ply filter in which the base and outer plies can be attached along one common edge, and held in place via opposing hook and loop fasteners established along each of the interconnected and perimeter defining edges, with the outer ply including the cutouts for seating around the mounting grommets securing the base ply;

FIG. 14 presents a modification of FIG. 13 in which the outer ply is presented in reduced perimeter dimension, in order to seat against an inwardly spaced arrangement of hook and loop fasteners associated with the outer face of the base ply, and so that the opposing inner face of the outer ply adheres inwardly of the arrangement of grommets associated with the base ply;

FIG. 15 is an arrangement of a further configuration of a dual ply filter assembly, attached along a common edge as shown in FIG. 13, and further including opposing magnetic strips established between the base and outer plies for releasably attaching the filter layers in place;

FIG. 16 is a plan view illustration of a yet further configuration of a dual ply filter and depicting a zippered extending edge defined along an interior the outer attached mesh ply for providing access between the base and outer plies, such as which can be securely joined together along each of the four interconnecting edges, to permit interior cleaning between the outer and inner plies;

FIG. 17 is an illustration similar to FIG. 16 and depicting a slit formed in the outer mesh ply in substitution of the zipper, along with opposing hook and loop portions established between the plies in proximity to the slit in order to permit access to the interior between the plies to permit cleaning, this configuration also being deployed without the hook and loop portions, such as leaving a stand-alone slit which permits access between the outer and base plies;

FIG. 18 presents a further plan view illustration similar to FIG. 16 and depicting intermediate zippered edges dividing the outer mesh ply into separable halves for gaining access to the base ply; and

FIG. 19 is an arrangement of a yet further embodiment of a dual ply filter joined along three sides and having a fourth openable and reclosable side for permitting side access between the plies for cleaning, as well as for allowing installation of a third removable mesh ply having a rigid form defining outer frame.

### DETAILED DESCRIPTION OF THE PREFERRED EMBODIMENTS

With reference to the attached illustrations, the present invention discloses a variety of configurations of a multi-ply filter (or flap filter) for application over an air intake opening and which provides for ease of cleaning without removal from the equipment, as well as for varying airflow, such as by removal of a ply, during higher static pressure levels.

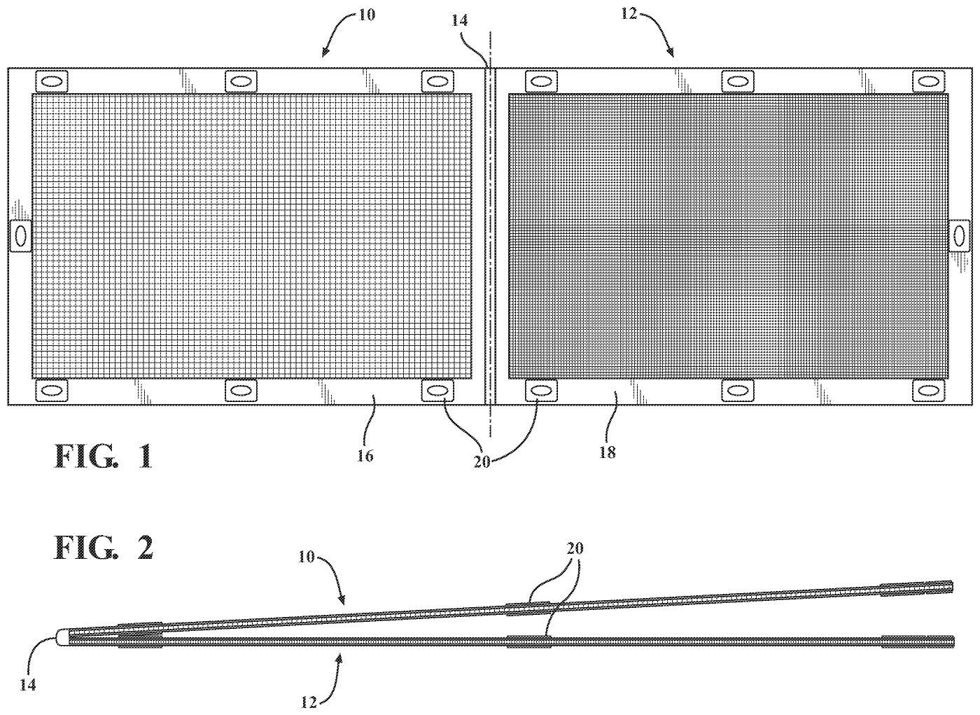

Referring initially to FIGS. 1-2, related unfolded plan and side views are depicted of a flap-style dual filter assembly, according to a non-limiting variant of the present invention and depicting first 10 and second 12 plies of varying mesh thickness (outer ply 10 typically having larger mesh and inner/base ply 12 having finer mesh) which are bound along a common edge 14, such as sewn together as depicted, for attachment to an intake face of such as an air handling unit 2 (see FIG. 5) and within which is defined the air intake opening. The mesh plies 10 and 12 each further exhibit an outer reinforced perimeter edge (see respectively at 16 for mesh ply 10 and at 18 for mesh ply 12).

Pluralities of grommets 20 are configured along each of the interconnected sides of the reinforced perimeter edges 16 and 18 and, as shown in the side view of FIG. 2, align upon folding the plies 10/12 in an overlapping configuration in which the perimeter arranged supporting grommets and reinforced edges are aligned prior to attachment to the intake face. As will be further described throughout the succeeding views, a variety of fasteners can be employed for securing the multi-ply filter screen to the air handling unit over the intake opening and can include any of screws/washers, twist lock fasteners, toggle lock fasteners, spin lock fasteners and the like. This can further include incorporating channel track sections in a perimeter defined fashion around the intake opening for receiving the mounting hardware for securing the multi-ply filter in place. In this fashion, and when it is desired to remove the outer mesh ply 10, the same can be disengaged from the mounting fasteners and can be folded or rolled prior to being secured along a side of the intake unit (not shown) so as not to interfere with the normal operation of the unit with the remaining mesh ply 12 remaining in place.

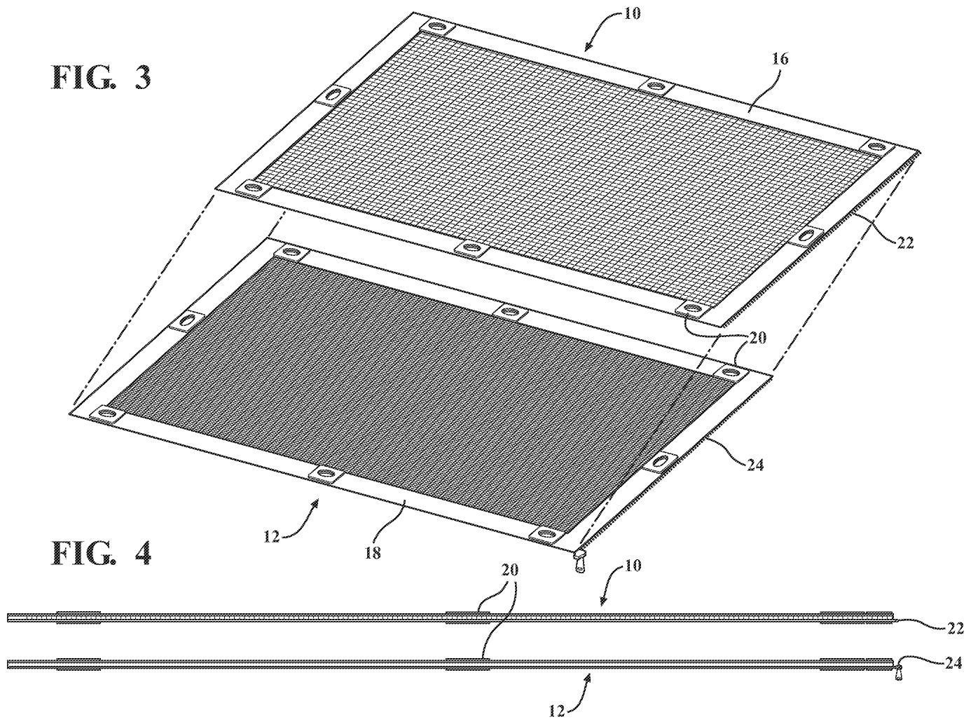

Proceeding to FIG. 3, an exploded perspective view (see also side plan view of FIG. 4) is shown of a related dual filter assembly according to a further non-limited variant of the present invention, and in which the common sewn edge 14 is substituted by a zippered connection, this shown by zippered edges 22 and 24 extending along a common edge established between the outer 10 and base 12 plies for quickly connecting the mesh plies 10/12 prior to mounting to the intake unit and which, as further depicted in the related side plan view of FIG. 4, allows for the outer mesh ply 10 to be easily removed from the intake unit, without removal of the base ply 12. Without limitation, this embodiment can also be provided without the zipper connection and by which the outer ply 16 can be attached in overlapping fashion over the base ply 12 and via any fastener arrangement as described herein;

FIG. 5 is an exploded environmental view of a dual filter assembly, see inner base ply 26 and outer ply 28, according to a further preferred embodiment and including the base ply 26 having the outer perimeter edge grommets 20 established around a reinforced edge 30 and secured to the air intake face via twist lock fasteners 32 (without limitation any of toggle style fasteners, screws or other fastening methods can be employed not limited to those described herein). The outer ply 28 exhibits a modified and segmented outer perimeter with cutouts 34 separating reinforced perimeter locations 36, these aligning with the arrangement of the grommets 20 and inserted fasteners 32 upon assembly in order to provide a flush appearance over the intake opening.

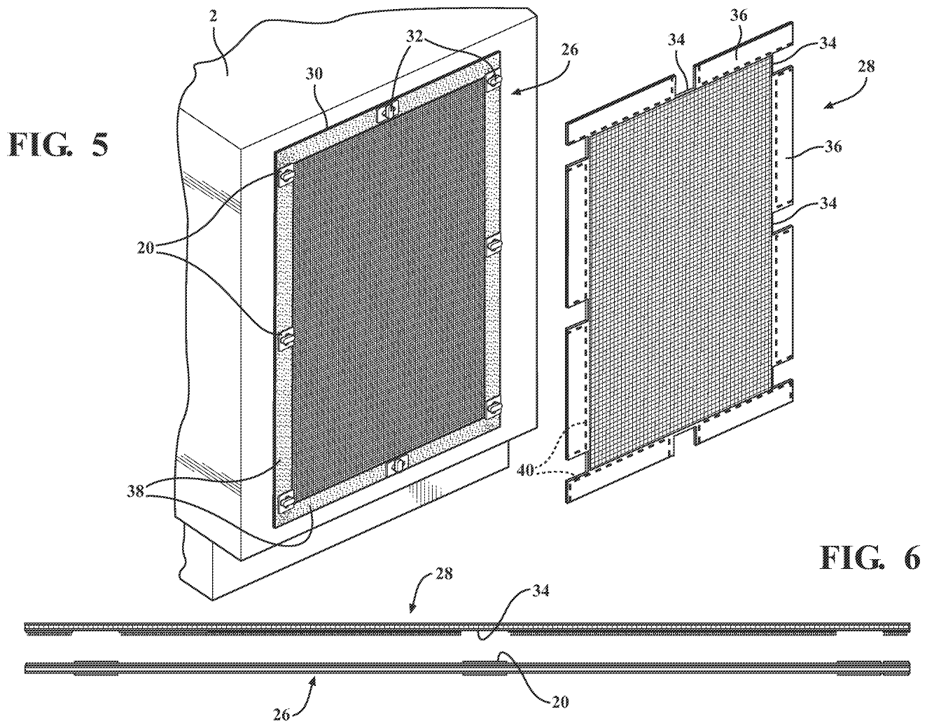

As further shown, each of the base 26 and outer 28 plies exhibit opposing hook and loop (e.g. Velcro®) portions, see as depicted at 38 upon exposed surface of inner ply reinforced outer trim 30 which mates with opposing inwardly facing hook and loop portions, representatively shown at 40 upon inwardly facing surfaces of the separated reinforced perimeter locations 36 for releasably attaching the outer ply 28 without requiring removal of the base ply 26. Proceeding to FIG. 6, a side plan view is shown of the filter assembly of FIG. 5 and similarly depicts the overlapping configuration in which the perimeter arranged supporting grommets 20 of the base layer 26 and the cutout locations 34 of the upper mesh layer 28 are aligned upon attachment to the intake face.

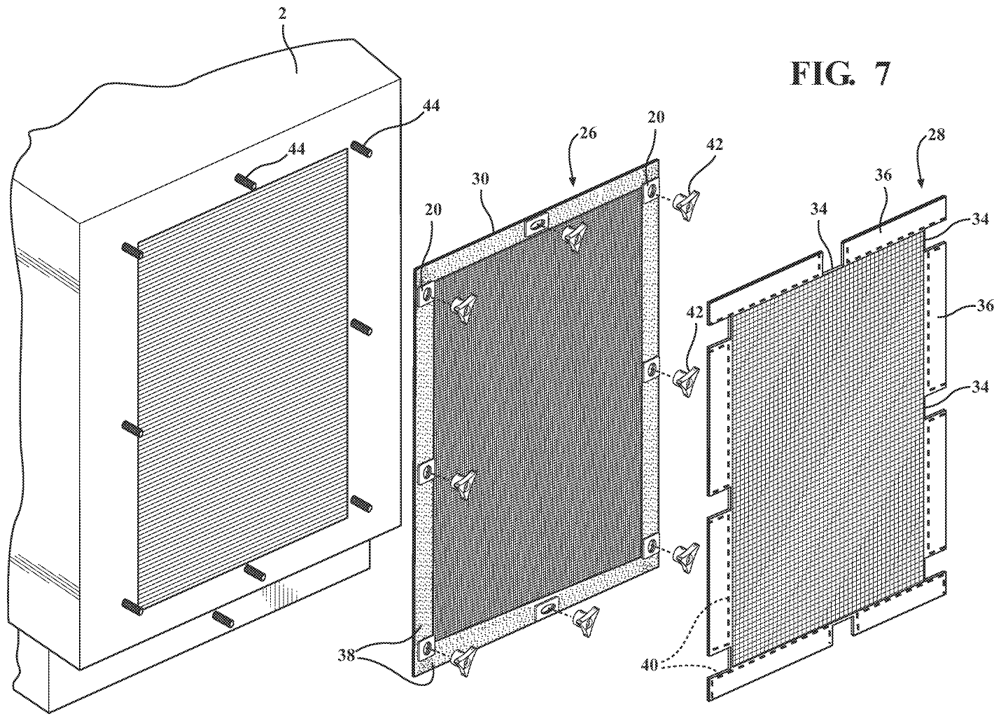

FIG. 7 is an exploded environmental view of a dual filter assembly according to a further preferred embodiment and including spin lock fasteners 42 for securing a base ply 26 similarly constructed that shown in FIG. 5 and secured over threaded posts 44 projecting from the air intake face, the outer ply 28 likewise being similarly constructed as in FIG. 5 and releasably securing to the base ply 26 via opposing hook and loop fasteners (see again at 38 and 40).

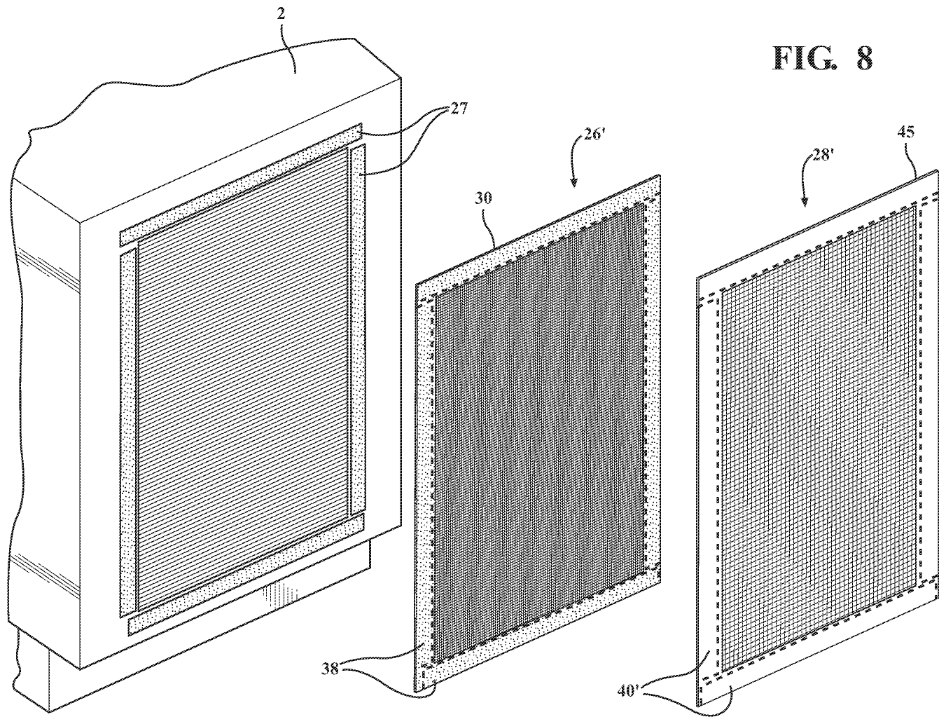

FIG. 8 presents an exploded view of a further variant of a dual filter assembly and depicting a reconfiguration of each of the base ply, at 26′, attached to the intake face 2 by a first set of hook and loop fasteners, including interconnected hook and loop strips 27 secured to the intake face opposed by additional hook and loop strips (not shown) arrayed upon the inner face of the base ply 26′. The outer ply, at 28′, is secured to the base ply 26′ via a second set of hook and loop fasteners arranged upon opposing reinforced edges of the base and outer plies, this including the hook and loop strips 38 previously shown in combination with reconfigured opposing hook and loop strips 40′ (in comparison to the segmented strips 40 depicted in FIG. 7 arrayed on the rear face of the outer ply in FIG. 7, the same having a reinforced outer edge 45).

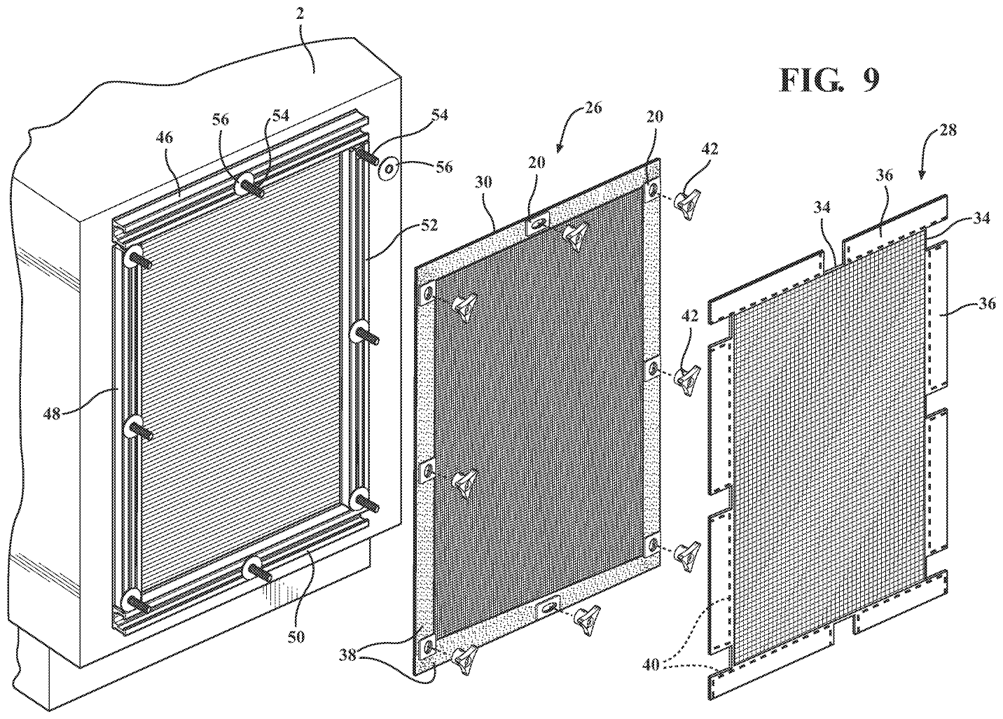

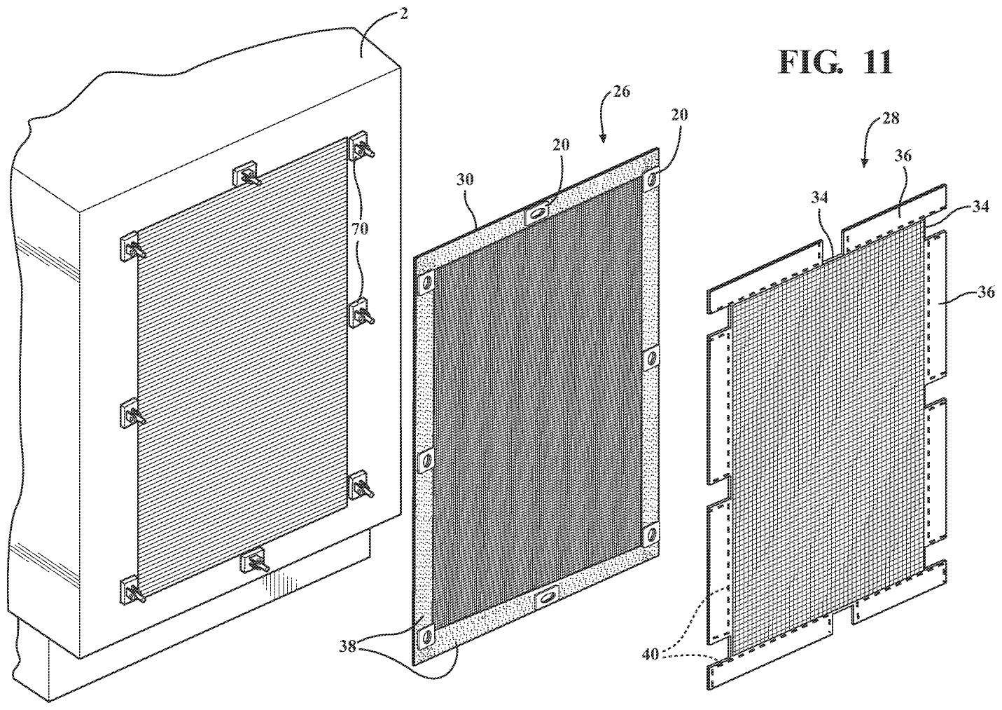

FIG. 9 presents an exploded view similar to FIG. 7 of a modified spin lock fastener mounting arrangement for the dual filter assembly utilizing a four sided track assembly, see track sections 46, 48, 50 and 52 which are mounted to the air intake face 2 for supporting a variant of threaded mounting bolts 54 with enlarged support washers 56. Without limitation, this configuration may also utilize Twist lock fasteners as depicted in FIG. 5, or may use a toggle style fastener (as subsequently described and shown in FIG. 11).

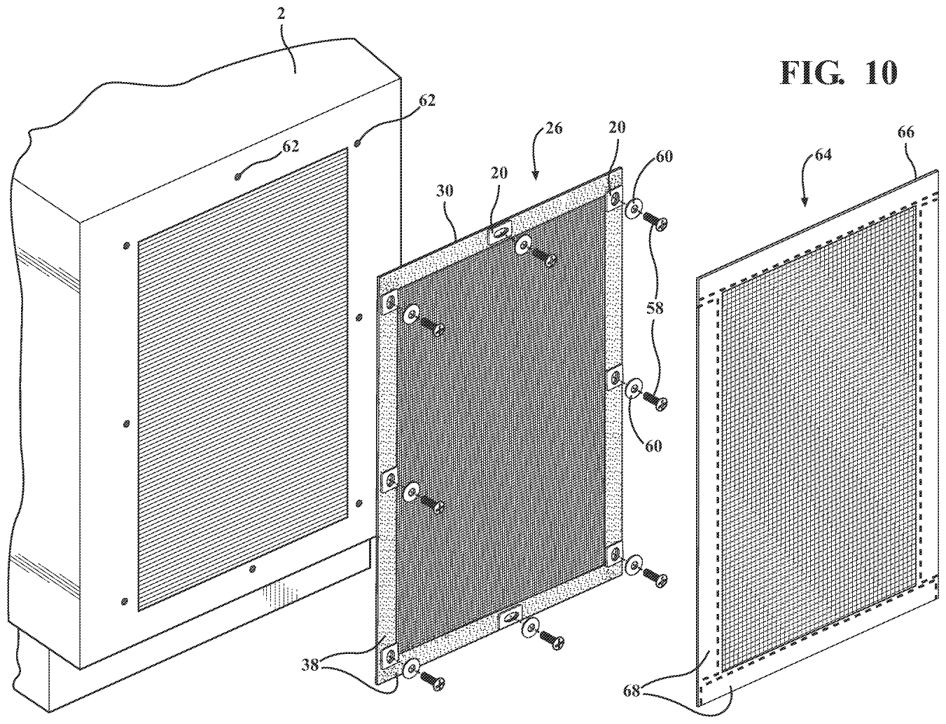

Proceeding to FIG. 10, a further exploded perspective view is shown of a mounting arrangement for the dual filter assembly, including reconfigured screw 58 and washer 60 mounting fasteners provided for mounting the inner mesh layer 26 (see also apertures 62 configured in perimeter defining fashion about the intake face) to the intake unit 2. In combination, a redesigned outer ply 64 is provided with an uninterrupted exterior reinforced edge 66 for securing over the (typically flattened) heads of the screws 58, via the opposing arrangements of hook and loop fasteners (again at 38 for inner ply 26 and further at 68 for outer ply 64), and in order to releasably secure the upper ply 66 to the lower or base ply 26 in a flush manner, once the latter is mounted to the intake unit 2.

FIG. 11 is an exploded environmental view of a dual filter assembly according to a further preferred embodiment largely, largely identical to that shown in FIG. 5, and including the base ply 26 with outer perimeter edge grommets 20 secured to the intake face of the structure 2 via toggle lock fasteners 70 (as opposed to the twist lock fasteners shown in FIG. 5). The outer ply 28 again includes modified and segmented outer perimeter cutouts 34 aligning with the arrangement of the fasteners 70, with each of the base and outer plies exhibiting opposing hook and loop (e.g. Velcro®) portions 38 and 40 for releasably attaching the outer ply without requiring removal of the base ply 26.

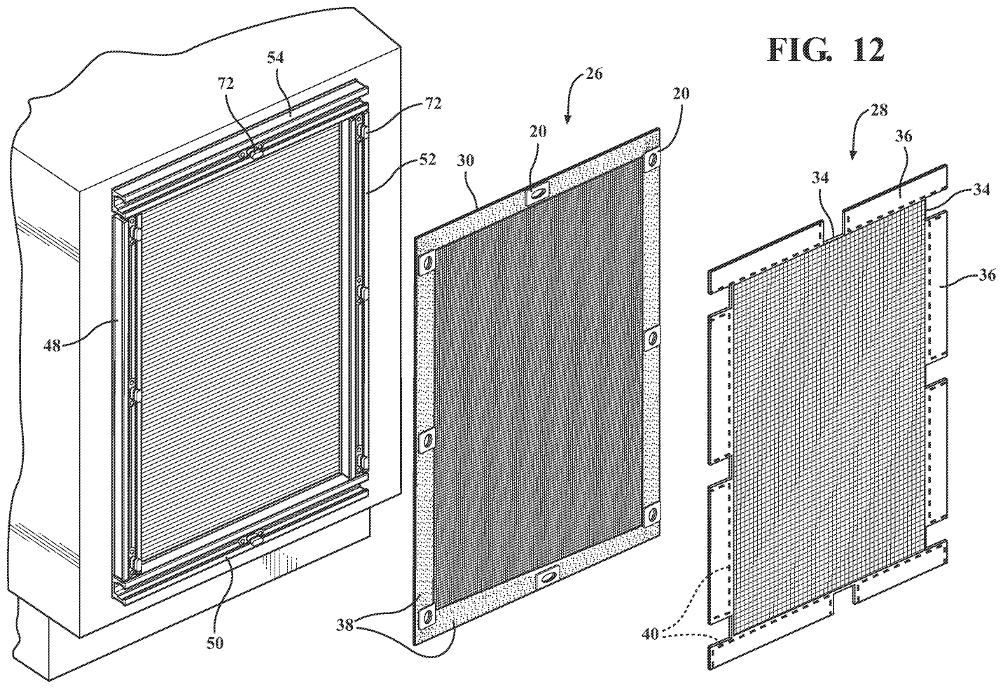

Proceeding to FIG. 12, presented is an exploded view similar to as shown in the embodiment of FIG. 8 and in which the spin lock fasteners are substituted by twist lock fasteners 72 which are mounted within each of the perimeter defining tracks 48, 50, 52 and 54 for securing the inner or base ply 26.

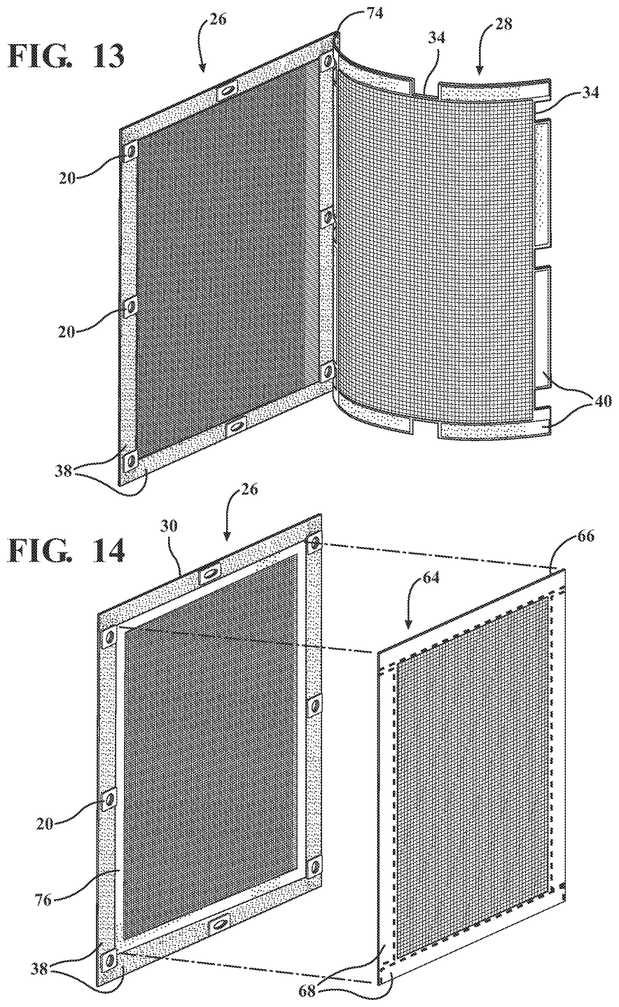

FIG. 13 provides an illustration of a further configuration of the dual ply filter, in which the base 26 and outer 28 plies can be attached along one common edge, shown at 74. This can again be accomplished by sewing or otherwise affixing the plies together. The plies 26/28 are held in place via the opposing hook and loop fasteners 38 and 40 established along each of the interconnected and perimeter defining edges, with the outer ply 28 again including the aligning cutouts 34 for seating around the mounting grommets 20 securing the base ply 26.

FIG. 14 presents a modification of FIG. 13 in which the outer ply 64 is presented in a reduced perimeter dimension, this in order to seat against an inwardly spaced arrangement of hook and loop fasteners (likewise perimeter extending and depicted at 76 which is framed by the outer perimeter edge 30 associated with the outer face of the base ply 26. In this manner, the opposing inner face of the outer ply 64 adheres inwardly of the arrangement of grommets 20 associated with the base ply 26.

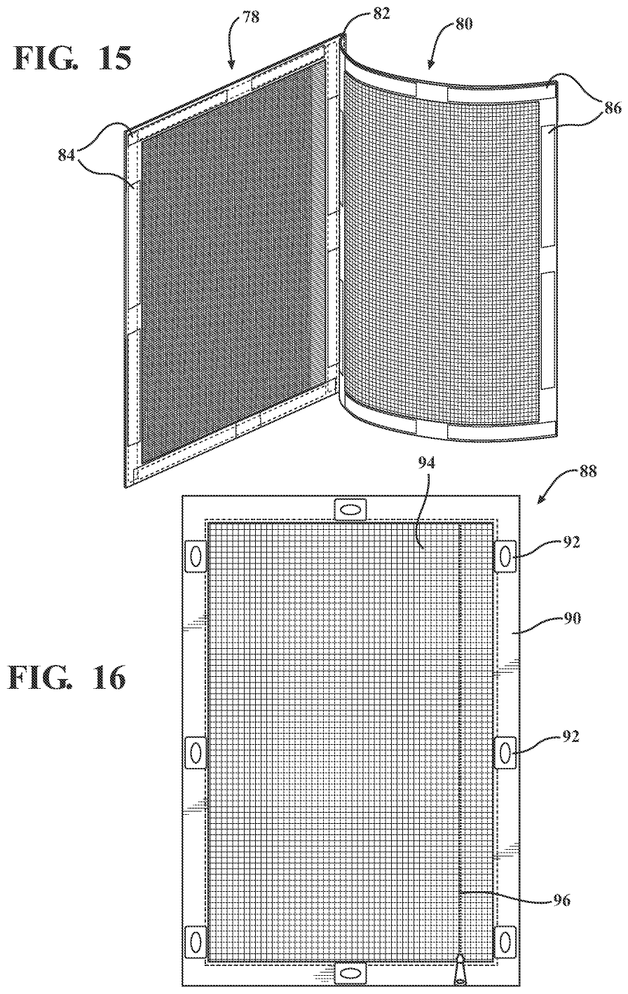

FIG. 15 presents an arrangement of a further configuration of a dual ply filter assembly, including inner ply 78 and outer ply 80, and which are attached along a common edge 82 (such as again by sewing or otherwise affixing) in similar fashion as shown in FIG. 13. The dual ply filter assembly further includes opposing magnetic strips, including at 84 for base ply 78 and at 86 for opposing outer ply 80 for releasably attaching the filter layers in place. As previously described, the outer ply 80 can be detached from the inner ply 78, via the opposing hook and loop fasteners, and rolled up or otherwise pinned to the intake structure 2 without the requirement of removing from the assembly.

FIG. 16 presents a plan view illustration of a yet further configuration of a one piece dual ply filter, generally at 88, including a reinforced outer perimeter edge 90 with integrated grommets 92 for securing to the intake face via any of the fastener arrangements previously described. The inner mesh ply associated with the base filter layer is hidden from view and shown at 94 is the larger mesh associated with the outer ply, further depicting a zippered extending edge 96 defined along an interior the outer attached mesh ply for providing access between the base and outer plies, which can be securely joined together along each of the four interconnecting edges. In this fashion, the outer ply 94 is unzipped to provide access between the mesh layers to permit interior cleaning between the outer and inner plies.

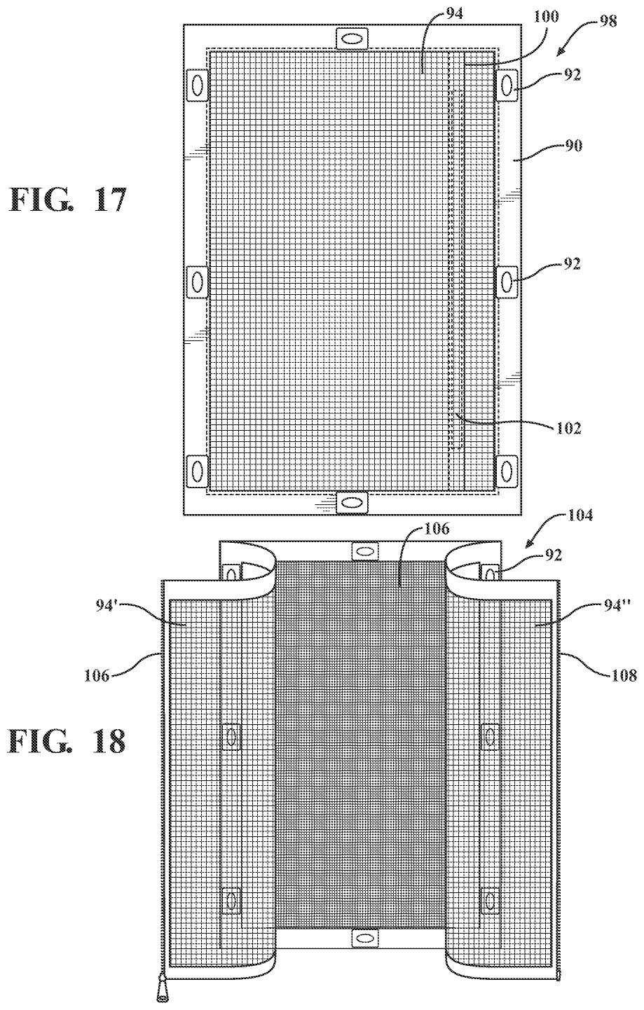

FIG. 17 is an illustration similar to FIG. 16 of a further variant of a one piece dual ply filter 98, depicting a slit 100 formed in the outer mesh ply 94 in substitution of the zipper. In combination, opposing hook and loop portions (see as representatively depicted at 102) established between the plies in proximity to the slit 100, this in order to permit access to the interior between the plies to permit cleaning. Without limitation, this configuration can also be deployed without the hook and loop portions, this leaving a stand-alone slit which permits access between the outer and base plies.

FIG. 18 presents a further plan view illustration similar to FIG. 16, at 104, of a further variant of a dual ply filter assembly and depicting intermediate zippered edges, at 106 and 108, dividing the outer mesh ply into separable halves (see at 94′ and 94″) for gaining access to the base ply, further revealed at 106. As previously described, tie downs or other any other retaining clips or straps can be utilized for securing the unzipped halves 94′/94″ of the outer ply and without removing the inner ply 106 from the air intake unit.

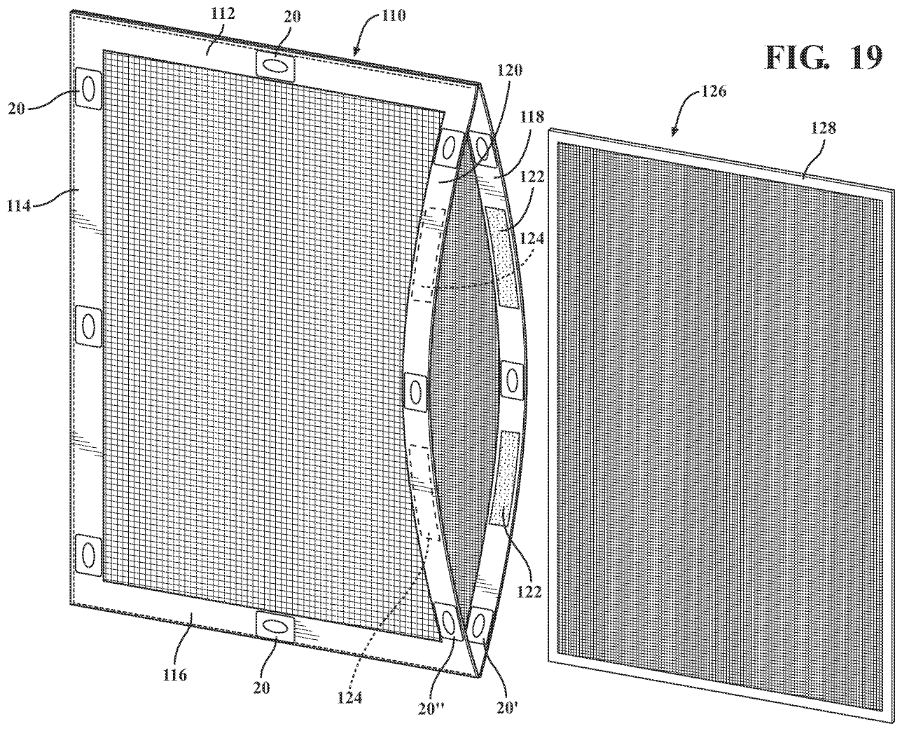

Finally, FIG. 19 provides an arrangement of a yet further embodiment of a dual ply filter, generally at 110, which is joined along three reinforced perimeter edges 112, 114 and 116 with spaced apart integrated grommets 20. A fourth openable and reclosable side includes inner separating layer 118 and outer layer 120, having subset grommet portions 20′ and 20″ along with opposing hook and loop portions 122 and 124, for permitting side access between the plies for cleaning.

A third removable mesh ply is shown at 126 and depicts a rigid form defining outer frame 128. Upon opening the fourth extending edge of the dual ply filter 110, the third mesh ply 126 can be inserted or removed depending upon the desired airflow handling characteristics of the application, this further a factor of the relative mesh sizing of the third ply as compared to that of the outermost (e.g. typically largest) and innermost (typically smallest) mesh sizes. The third intermediate positioned ply 126 can have any construction not limited to that described herein.

Without limitation, a third or tertiary mesh ply according to any configuration can be provided according to any of the disclosed embodiments and by which the third ply is interposed in any fashion between the (primary) base mesh and (secondary) outer mesh ply. The present invention also contemplates any combination of plies, such as including four or more, as within the scope of the invention.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A filter assembly for securing to an intake face of an air handling unit, comprising:
a base mesh ply adapted to being secured to the intake face in order to cover an opening of the air handling unit; and
an outer mesh ply attached to said base mesh ply, said outer ply being manipulated to permit access to said base ply without removal of said base ply from the air handling unit.

2. The filter assembly of claim 1, further comprising at least said base mesh ply incorporating a reinforced edge with spaced apart grommets receiving fasteners for securing to the intake face.

3. The filter assembly of claim 1, further comprising said base and outer mesh plies being joined together along at least one common edge.

4. The filter assembly of claim 3, further comprising any of hook and loop fasteners, zippers, or magnetic strips for joining said base and outer mesh plies.

5. The filter assembly of claim 2, further comprising said outer ply having a modified and segmented outer perimeter with cutouts aligning with an arrangement of the fasteners for securing said base ply to the air handling unit.

6. The filter assembly of claim 5, said fasteners further comprising any of twist lock fasteners, toggle lock fasteners, spin lock fasteners, or screws and washers.

7. The filter assembly of claim 6, further comprising any of threaded bolts, interiorly threaded apertures or channel track sections adapted to being secured to the intake face for mounting said base mesh layer.

8. The filter assembly of claim 2, further comprising said outer ply having a reduced perimeter dimension seating against said base ply inwardly from fasteners securing said base ply to the intake face, an opposing inner face of said outer ply adhering inwardly of the arrangement of said grommets associated with the base ply and said fasteners projecting through said grommets.

9. The filter assembly of claim 3, further comprising said base and outer mesh plies being secured along each of four interconnected edges, a zippered extending edge further defined along an interior the outer attached mesh ply for providing access between said plies.

10. The filter assembly of claim 3, further comprising said base and outer mesh plies being secured along each of four interconnected edges, a slit extending along an interior of said outer mesh ply in combination with opposing hook and loop portions established between said plies in proximity to said slit for providing access between said plies.

11. The filter assembly of claim 1, further comprising intermediate zippered edges dividing said outer mesh ply into separable halves for gaining access to said base ply.

12. The filter assembly of claim 1, further comprising said base and outer mesh plies being secured along each of three interconnected edges, and having a fourth openable and reclosable side for permitting side access between said plies.

13. The filter assembly of claim 12, further comprising a third removable mesh ply having a rigid form defining outer frame insertable through said fourth openable side between said base and outer mesh plies.

14. The filter assembly of claim 1, further comprising a third removable mesh ply having a rigid form defining outer frame insertable between said base mesh ply and said outer mesh ply.

15. A filter assembly for securing to an intake face of an air handling unit, comprising:
a base mesh ply adapted to being secured to the intake face in order to cover an opening of the air handling unit;
an outer mesh ply attached to said base mesh ply, said outer ply being manipulated to permit access to said base ply without removal of said base ply from the air handling unit; and
a third mesh ply removably inserted between said base mesh ply and said outer ply.

16. The filter assembly of claim 15, further comprising said base and outer mesh plies being secured along each of three interconnected edges, and having a fourth openable and reclosable side for permitting side access between said plies.

17. The filter assembly of claim 15, further comprising said third removable mesh ply having a rigid form defining outer frame insertable through said fourth openable side between said base and outer mesh plies.

18. A filter assembly for securing to an intake face of an air handling unit, comprising:
a base mesh ply adapted to being secured to the intake face in order to cover an opening of the air handling unit;
an outer mesh ply attached to said base mesh ply, said base and outer mesh plies being secured along each of three interconnected edges, and having a fourth openable and reclosable side for permitting side access between said plies so that said outer ply is manipulated to permit access to said base ply without removal of said base ply from the air handling unit; and
a third removable mesh ply having a rigid form defining outer frame insertable through said fourth openable side between said base and outer mesh plies.
